(19) United States
(12) Patent Application Publication
(10) Pub. No.: US 2009/0067948 A1
(43) Pub. Date: Mar. 12, 2009

(54) Fastening Device

(76) Inventor: Te-Shun CHUNG, Taichung City (TW)

Correspondence Address: Dr. BANGER SHIA, 102 Lindencrest Ct., Sugar Land, TX, 77479-5201, US

(21) Appl. No.: 11/852,312

(22) Filed: Sep. 9, 2007

(51) Int. Cl. F16B 37/14

(52) U.S. Cl. 411/429

(57) ABSTRACT

A fastening device includes a threaded bolt, a first nut and a second nut. The threaded bolt includes a head and a threaded body extended from the head. The first nut is for engagement with the threaded body to sandwich at least one object between the first nut and the head. The first nut includes a convex face on a side. The second nut includes a concave face for tight contact with the convex face of the first nut so that the second nut causes the first nut to shrink and clamp the threaded body when the second nut is in firm engagement with the threaded body.

### BACKGROUND OF INVENTION

1. Field of Invention

The present invention relates to a reliable fastening device.

2. Related Prior Art

A typical fastening device includes a threaded bolt and a nut for engagement with the threaded bolt. To prevent undesired slacking of the nut on the threaded bolt, anti-slacking agent may be provided between the bolt and the threaded bolt. However, there are drawbacks in the use of the anti-slacking agent. Firstly, the anti-slacking agent is expensive. Secondly, the life of the anti-slacking agent is short. Thirdly, repeated use of the anti-slacking agent is not possible. Fourthly, due to the use of the anti-slacking agent, it is difficult to disengage the nut from the threaded bolt if necessary.

Alternatively, two nuts may be engaged with a threaded bolt. The performance of two nuts engaged with a threaded bolt is better than that of only one nut engaged with a threaded bolt. The performance of the former is however not satisfactory.

Therefore, the present invention is intended to obviate or at least alleviate the problems encountered in prior art.

### SUMMARY OF INVENTION

The primary objective of the present invention to provide a reliable fastening device.

According to the present invention, a fastening device includes a threaded bolt, a first nut and a second nut. The threaded bolt includes a head and a threaded body extended from the head. The first nut is for engagement with the threaded body to sandwich at least one object between the first nut and the head. The first nut includes a convex face on a side. The second nut includes a concave face for tight contact with the convex face of the first nut when the second nut is in firm engagement with the threaded body so that the second nut causes the first nut to shrink and clamp the threaded body.

The first nut may include at least one internal longitudinal groove defined therein for allowing the shrinkage thereof.

A washer may be provided between the first nut and the object. The washer includes a screw hole for receiving the threaded body and a convex face on a side. The first nut includes a concave face for tight contact with the convex face of the washer when the first nut is in firm engagement with the threaded body so that the first nut causes the washer to shrink and clamp the threaded body.

The washer may include at least one internal longitudinal groove defined therein for allowing the shrinkage thereof.

A socket may be used to drive any of the head, first and second nuts. The socket may include at least one internal longitudinal ridge. Each of the head, first and second nuts includes at least one external longitudinal groove for receiving the internal longitudinal ridge.

Each of the head, first and second nuts may include a tapered periphery. The socket includes a tapered cavity for receiving the tapered periphery of any of the head, first and second nuts.

A clip may be used to restrain any of the head, first and second nuts in the socket. Each of the head, first and second nuts may include an annular groove. The socket includes at least one slot defined therein. The clip includes at least one curved portion for insertion into the annular groove of any of the head, first and second nuts through the slot of the socket.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is an exploded view of a fastening device according to the preferred embodiment of the present invention.

FIG. 2 is a perspective view of the fastening device shown in FIG. 1.

FIG. 3 is a partial cross-sectional view of the fastening device shown in FIG. 2.

FIG. 4 is another partial cross-sectional view of the fastening device shown in FIG. 2.

FIG. 5 is a cross-sectional view of two plates joined together with the fastening device shown in FIG. 2.

### DETAILED DESCRIPTION OF PREFERRED EMBODIMENT

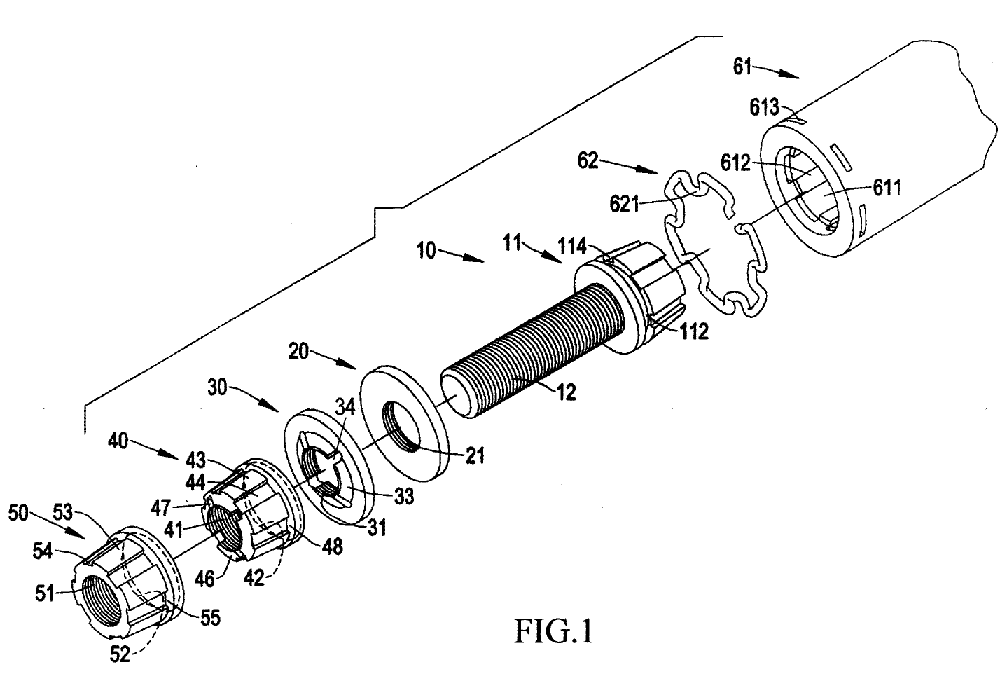

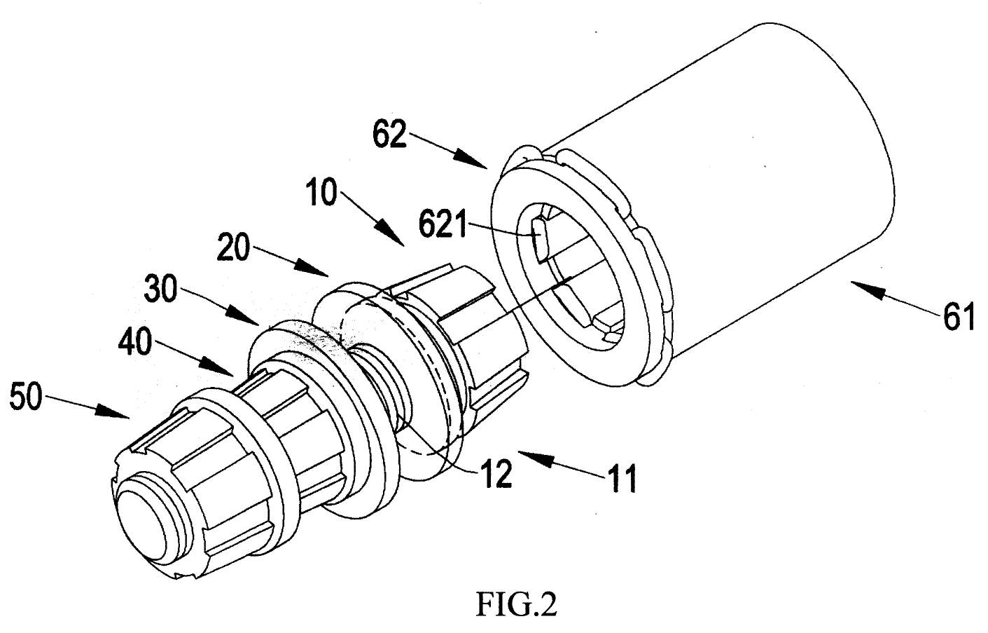

Referring to FIGS. 1 and 2, according to the preferred embodiment of the present invention, a fastening device includes a threaded bolt 10, a first washer 20, a second washer 30, a first nut 40, a second nut 50, a socket 61 and a clip 62.

The threaded bolt 10 includes a tapered head 11 at a first end and a threaded body 12 at a second end. The tapered head 11 is shaped like a conical frustum, unlike the head of a typical threaded bolt. The tapered head 11 is tapered in a direction from the second end to the first end. An annular groove 112 is defined in the tapered head 11. Longitudinal grooves 114 are defined in the tapered head 11, in communication with the annular groove 112.

The first washer 20 includes a screw hole 21 for receiving the threaded body 12, unlike a typical washer that includes a plain aperture.

The second washer 30 includes a screw hole 31 for receiving the threaded body 12, a flat face on a side, a convex face 33 on an opposite side and internal longitudinal grooves 34 defined in the wall of the screw hole 31. All of the internal longitudinal grooves 34 extend from the flat face to the convex face 33.

The first nut 40 includes a screw hole 41 for receiving the threaded body 12, a concave face 42 on a side for contact with the convex face 33, a convex face 46 on an opposite side, internal longitudinal grooves 47 defined in the wall of the screw hole 41, a tapered periphery 43, external longitudinal grooves 44 defined in the tapered periphery 43, an annular groove 48 defined in the tapered periphery 43, in communication with the external longitudinal grooves 44. All of the internal longitudinal grooves 47 extend from the concave face 42 to the convex face 46. The diameter of the tapered periphery 43 gets smaller in a direction from the concave face 42 to the convex face 46.

The second nut 50 includes a screw hole 51 for receiving the threaded body 12, a concave face 52 on a side for contact with the convex face 46, a convex face on an opposite side, a tapered periphery 53, external longitudinal grooves 54 defined in the tapered periphery 53 and an annular groove 55 defined in the tapered periphery 53, in communication with the external longitudinal grooves 54. The diameter of the tapered periphery 53 gets smaller in a direction from the concave face 52 to the flat face.

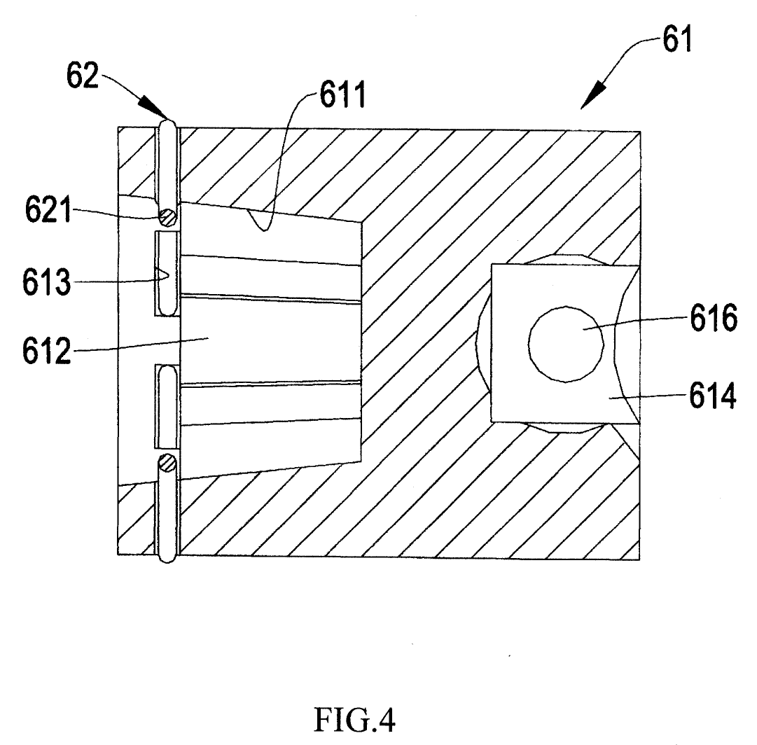

Referring to FIGS. 1 and 4, the socket 61 includes a square cavity 614 at an end, four holes 616 in the wall of the square cavity 614, a tapered 11 cavity 611 at an opposite end, longitudinal ridges 612 on the wall of the tapered cavity 611 and slots 613 in communication with the tapered cavity 611. The clip 62 is an elastic element with curved portions 621. The clip 62 is provided around the socket 61 so that the curved portions 621 are inserted into the tapered cavity 611 through the slots 613.

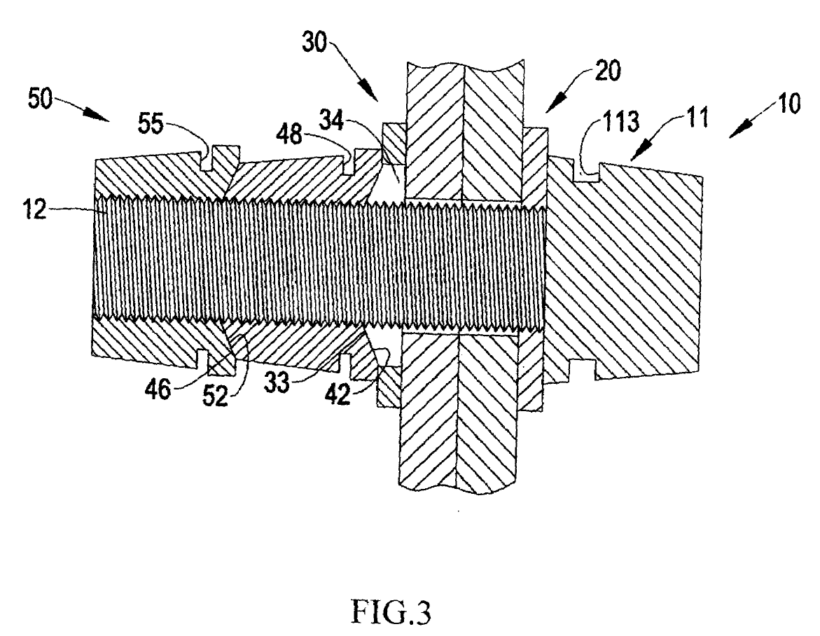

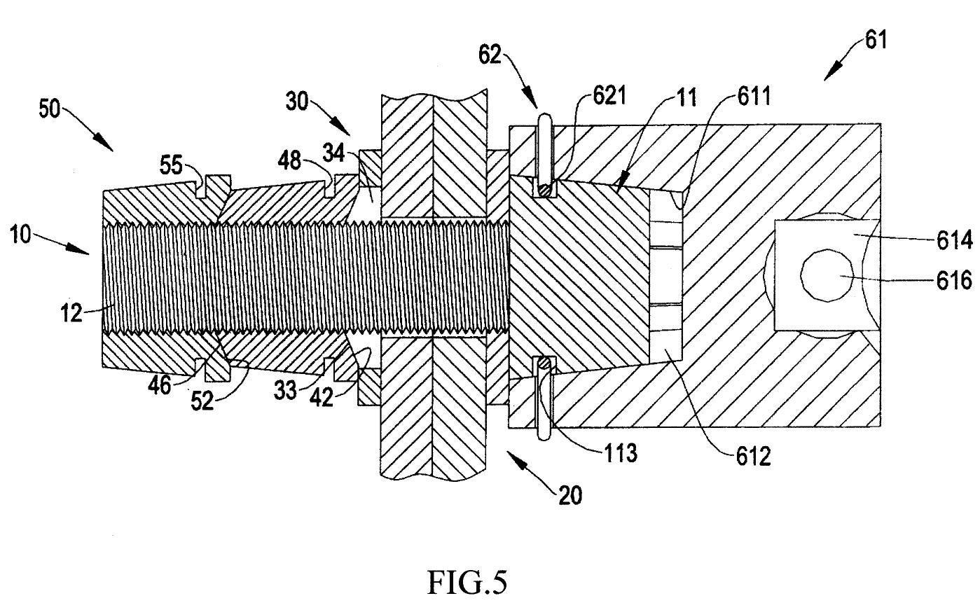

Referring to FIGS. 3 and 5, two plates are joined together with the fastening device. The plates are sandwiched between the first washer 20 and the second washer 30. The threaded body 12 is driven through the first washer 20, the plates and the second washer 30.

The first nut 40 is engaged with the threaded body 12 so that the first washer 20, the plates and the second washer 30 are sandwiched between the tapered head 11. The concave face 42 is in contact with the convex face 33. Thus, the first nut 40 causes the second washer 30 to clamp the threaded body 12 tighter as the engagement of the first nut 40 with the threaded body 12 gets tighter. The internal longitudinal grooves 34 allow the second washer 30 to shrink and clamp the threaded body 12.

The second washer 30 is engaged with the threaded body 12 so that the concave face 55 is in contact with the convex face 46. Thus, the second nut 50 causes the first nut 40 to clamp the threaded body 12 tighter as the engagement of the second nut 50 with the threaded body 12 gets tighter. The internal longitudinal grooves 47 allow the first nut 40 to shrink and clamp the threaded body 12.

The contact of the concave face 42 with the convex face 33 and that of the concave face 52 with the convex face 46 cause the second washer 30 and the first nut 40 to clamp the threaded body 12, thus preventing undesired slacking.

The socket 61 is provided on the tapered head 11, the first nut 40 or the second nut 50 so that the ridges 612 are disposed in the longitudinal grooves 114, 44 or 54. Thus, the socket 61 is operable to rotate the threaded bolt 10, the first nut 40 or the second nut 50. The curved portions 621 of the clip 62 are disposed in the annular groove 112, 48 or 55 so that the socket 61 is retained on the threaded bolt 10, the first nut 40 or the second nut 50.

A square tip of a one-way wrench (or Hatchet wrench H) is inserted in the square cavity 614. A spring-biased ball installed on the square tip can be disposed in any of the holes 616 for retaining the square tip in the square cavity 614. Thus, the one-way wrench can be pivoted to and fro to rotate the socket 61 that in turn rotates the threaded bolt 10, the first nut 40 or the second nut 50.

In another embodiment, the first washer 20 may be omitted. In still another embodiment, the second washer 30 may be omitted, and the concave face 42 may be replaced with a flat face.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A fastening device comprising:
a threaded bolt comprising a head and a threaded body extended from the head;
a first nut for engagement with the threaded body to sandwich at least one object between the first nut and the head, the first nut comprising a convex face on a side; and
a second nut comprising a concave face for tight contact with the convex face of the first nut so that the second nut causes the first nut to shrink and clamp the threaded body when the second nut is in firm engagement with the threaded body.

2. The fastening device according to claim 1 wherein the first nut comprises at least one internal longitudinal groove defined therein for allowing the shrinkage thereof.

3. The fastening device according to claim 1 comprising a washer between the first nut and the object, wherein the washer comprises a screw hole for receiving the threaded body and a convex face on a side, and the first nut comprises a concave face for tight contact with the convex face of the washer so that the first nut causes the washer to shrink and clamp the threaded body when the first nut is in firm engagement with the threaded body.

4. The fastening device according to claim 3 wherein the washer comprises at least one internal longitudinal groove defined therein for allowing the shrinkage thereof.

5. The fastening device according to claim 1 comprising a washer between the head and the object.

6. The fastening device according to claim 1 comprising a socket for driving any of the head, first and second nuts.

7. The fastening device according to claim 6 wherein the socket comprises at least one internal longitudinal ridge, and each of the head, first and second nuts comprises at least one external longitudinal groove for receiving the internal longitudinal ridge.

8. The fastening device according to claim 6 wherein each of the head, first and second nuts comprises a tapered periphery, and the socket comprises a tapered cavity for receiving the tapered periphery of any of the head, first and second nuts.

9. The fastening device according to claim 8 comprising a clip for restraining any of the head, first and second nuts in the socket.

10. The fastening device according to claim 9 wherein each of the head, first and second nuts comprises an annular groove, and the socket comprises at least one slot defined therein, and the clip comprises at least one curved portion for insertion into the annular groove of any of the head, first and second nuts through the slot of the socket.
